(19) United States
(12) Patent Application Publication
(10) Pub. No.: US 2007/0042206 A1
(43) Pub. Date: Feb. 22, 2007

(54) Polyamide-based multilayer film

(76) Inventor: Osamu Niwa, Fukushima (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/560,951

(22) PCT Filed: Jun. 17, 2004
(86) PCT No.: PCT/JP04/08833

§ 371 Date: Oct. 6, 2006

(30) Foreign Application Priority Data
Jun. 18, 2003 (JP) 2003174044

(51) Int. Cl. B32B 27/00

(52) U.S. Cl. 428/473.5

(57) ABSTRACT

The present invention relates to a polyamide-based multilayer film containing at least one saponified ethylene-vinyl acetate copolymer later and at least one polyamide layer; and provides a polyamide-based multilayer film having excellent resistance to boiling water and retort treatment, and a production method therefor.

### TECHNICAL FIELD

The present invention relates to a polyamide-based multilayer film containing a saponified ethylene-vinyl acetate copolymer layer and a polyamide layer, and a production method therefor.

### BACKGROUND ART

Polyamide-based multilayer films containing a saponified ethylene-vinyl acetate copolymer layer as a gas barrier layer are widely recognized as films suitable for packing foods, chemicals, etc., because polyamide-based multilayer films have outstanding mechanical strength, pinhole resistance and gas barrier properties.

However, when a polyamide-based multilayer film comes into contact with hot water of 85° C. or higher temperature, bubbles are created within the saponified ethylene-vinyl acetate copolymer layer, thereby whitening the film, reducing the transparency, making it difficult to see the content with the naked eye, and impairing the appearance of the film. Moreover, such polyamide-based multilayer films can not be brought into applications in which they are subjected to boiling water treatment or retort treatment at temperatures exceeding 85° C. because polyamide layers are likely to be oxidatively degraded by a mixed gas of oxygen and water vapor, and pinhole resistance, interlaminar strength and delamination strength are likely to be insufficient.

### DISCLOSURE OF THE INVENTION

An object of the present invention is to provide a polyamide-based multilayer film having excellent resistance to boiling water and retort treatment. In particular, the present invention provides a polyamide-based multilayer film that contains a saponified ethylene-vinyl acetate copolymer (hereinafter sometimes referred to as “EVOH”) layer as a barrier layer, can be subjected to boiling water treatment/retort treatment without resulting in film whitening, and has excellent mechanical strength, pinhole resistance and gas barrier properties; and a production method therefor.

The inventors conducted extensive research to achieve the object described above, and as a result, found that a polyamide-based multilayer film containing a specific saponified ethylene-vinyl acetate copolymer layer and a specific polyamide layer can overcome the aforementioned disadvantages. The inventors carried out further research and achieved the present invention.

In particular, the present invention provides the following polyamide-based multilayer films and production method.

Item 1. A polyamide-based multilayer film comprising at least one saponified ethylene-vinyl acetate copolymer layer and at least one polyamide layer,

the polyamide-based multilayer film being highly suitable for boiling water treatment and retort treatment.

Item 2. The polyamide-based multilayer film according to Item 1, wherein the saponified ethylene-vinyl acetate copolymer layer comprises a polyamide-based resin, an alcohol-based compound, and a saponified ethylene-vinyl acetate copolymer.

Item 3. The polyamide-based multilayer film according to Item 2, wherein the saponified ethylene-vinyl acetate copolymer layer further comprises an inorganic water-absorptive substance.

Item 4. The polyamide-based multilayer film according to Item 1, wherein the saponified ethylene-vinyl acetate copolymer layer is prepared by melt-blending a polyamide-based resin with an alcohol-based compound, and then adding a saponified ethylene-vinyl acetate copolymer.

Item 5. The polyamide-based multilayer film according to any one of Items 2 to 4, wherein the polyamide-based resin comprises an aliphatic nylon as a principal ingredient, the saponified ethylene-vinyl acetate copolymer has an ethylene content of 60 mol % or less, and the degree of saponification of the vinyl acetate moieties is at least 90 mol %.

Item 6. The polyamide-based multilayer film according to Item 1, wherein the polyamide layer is a layer comprising a polyamide and an antioxidant.

Item 7. The polyamide-based multilayer film according to Item 6, wherein the polyamide comprises an aliphatic polyamide as a principal ingredient and the antioxidant is a phenol-based antioxidant.

Item 8. The polyamide-based multilayer film according to Item 7, wherein the phenol-based antioxidant is at least one member selected from the group consisting of 3,9-bis[2-{3-(3-t-butyl-4-hydroxy-5-methylphenyl)propionyloxy}-1,1-dimethylethyl]-2,4,8,10-tetraoxaspiro[5,5]undecane; 6-[3-(3-t-butyl-4-hydroxy-5-methylphenyl)propoxy]-2,4,8,10-tetra-t-butylbenz[d,f][1,3,2]dioxaphosphepin; and pentaerythrityl-tetrakis[3-(3,5-di-t-butyl-4-hydroxyphenyl)propionate].

Item 9. The polyamide-based multilayer film according to any one of Items 1 to 8 consisting of at least one saponified ethylene-vinyl acetate copolymer layer and at least one polyamide layer.

Item 10. The polyamide-based multilayer film according to any one of Items 1 to 8 comprising at least three layers in the order of polyamide layer/saponified ethylene-vinyl acetate copolymer layer/polyamide layer.

Item 11. The polyamide-based multilayer film according to Item 10 further comprising an aromatic polyamide layer.

Item 12. A method for producing a polyamide-based multilayer film, the method comprising the steps of:

coextruding a saponified ethylene-vinyl acetate copolymer layer (A) prepared by melt-blending a polyamide-based resin with an alcohol-based compound and then adding an ethylene-vinyl acetate copolymer thereto, together with polyamide layers (B) and (C) each comprising a polyamide and an antioxidant, in the order of (B)/(A)/(C) to form a laminated film; and

biaxially stretching the film.

### DETAILED DESCRIPTION OF THE INVENTION

The present invention is described below in detail.

I. Saponified Ethylene-Vinyl Acetate Copolymer (EVOH) Layer

The EVOH layer of the present invention contains a polyamide-based resin, an alcohol-based compound and an EVOH as essential ingredients.

Examples of polyamide-based resins usable in the EVOH layer of the present invention are polycapramide (nylon-6), poly-ω-aminoheptanoic acid (nylon-7), poly-ω-aminononanoic acid (nylon-9), polyundecaneamide (nylon-11), polylauryllactam (nylon-12), polyethylenediamine adipamide (nylon-2,6), polytetramethylene adipamide (nylon-4,6), polyhexamethylene adipamide (nylon-6,6), polyhexamethylene sebacamide (nylon-6,10), polyhexamethylene dodecamide (nylon-6,12), polyoctamethylene adipamide (nylon-8,6), polydecamethylene adipamide (nylon-10,8), caprolactam/lauryllactam copolymers (nylon 6/12), caprolactam/ω-aminononanoic acid copolymers (nylon 6/9), caprolactam/hexamethylene diammonium adipate copolymers (nylon-6/6,6), lauryllactam/hexamethylene diammonium adipate copolymers (nylon-12/6,6), ethylenediamine adipamide/hexamethylene diammonium adipate copolymers (nylon-2,6/6,6), caprolactam/hexamethylene diammonium adipate/hexamethylene diammonium sebacate copolymers (nylon-6,6/6,10), ethylene ammonium adipate/hexamethylene diammonium adipate/hexamethylene diammonium sebacate copolymers (nylon-6/6,6/6,10), polyhexamethylene isophthalamide, polyhexamethylene terephthalamide, hexamethylene isophthalamide/terephthalamide copolymers, those that are prepared by modifying such polyamide-based resins with aromatic amines such as methylene benzylamine, m-xylylene diamine, etc., metaxylylene diammonium adipate, and the like. Such polyamide-based resins may be used singly or as a combination of two or more types. In particular, among such examples, hexamethylene isophthalamide/terephthalamide copolymers and like amorphous nylons, caprolactam/hexamethylene diammonium adipate copolymers (nylon-6/6,6), polylauryllactam (nylon-12) and like aliphatic nylons are preferably used.

Alcohol-based compounds usable in the EVOH layer of the present invention are not limited insofar as they contain an alcoholic OH group. Specific examples are ethyl alcohol, methyl alcohol, propyl alcohol, isopropyl alcohol, butyl alcohol, isobutyl alcohol, s-butyl alcohol, t-butyl alcohol, n-amyl alcohol, isoamyl alcohol, hexyl alcohol, heptyl alcohol, octyl alcohol, capryl alcohol, nonyl alcohol, decyl alcohol, undecyl alcohol, lauryl alcohol, tridecyl alcohol, myristyl alcohol, pentadecyl alcohol, cetyl alcohol, heptadecyl alcohol, stearyl alcohol, nonadecyl alcohol, eicosyl alcohol, ceryl alcohol, melissyl alcohol, allyl alcohol, crotyl alcohol, propargyl alcohol, cyclopentane alcohol, cyclohexane alcohol, benzyl alcohol, cinnamyl alcohol, furfuryl alcohol, fatty acid monoglycerides, and like univalent alcohols; glycol, diglycol, triglycol, polyethylene glycol, 1,2-propanediol, 1,3-propanediol, 1,2-butanediol, 1,3-butanediol, 2,3-butanediol, 1,4-butanediol, 1,5-pentane diol, 1,5-hexanediol, 1,6-hexanediol, neopentyl glycol, 1,2,6-hexanetriol, 1,3,5-hexanetriol, trimethyl propanol, glycerol, diglycerol, sorbitol, pentaerythritol stearate, pentaerythritol adipate, dipentaerythritol pyrrolidonecarboxylate, dipentaerythritol glutamate, maleic anhydride-modified wood rosin pentaerythritol, and like polyols; oligomeric polyvinyl alcohol-based resins; and like alcohol-based compounds. Diglycol, triglycol, 1,3-butanediol, 2,3-butanediol, 1,4-butanediol, 1,2,6-hexanetriol, 1,3,5-hexanetriol, glycerol, sorbitol, and like polyols are preferably used.

EVOHs usable in the EVOH layer of the present invention are not limited. EVOHs with an ethylene content of not more than 60 mol % (in particular, 20 to 55 mol %, and preferably 29 to 44 mol %) in which the degree of saponification of the vinyl acetate moieties is at least 90 mol % (in particular, 95 mol % or more) are preferably used.

Moreover, such EVOHs may contain small amounts of propylene, isobutene, α-octene, α-dodecene, α-octadecene, and like α-olefins; unsaturated carboxylic acids, and salts, partially-esterified alkyl esters, completely-esterified alkyl esters, nitrites, amides and anhydrides thereof; unsaturated sulfonic acids and salts thereof; and like comonomers insofar as the effects of the present invention are not adversely affected.

The melt index (MI) of such EVOHs is preferably 0.5 to 50 g/10 min (210° C., 2160 g load), and more preferably 1 to 35 g/10 min (210° C., 2160 g load) are preferable. Viscosities corresponding to melt indices of 0.5 g/10 min (210° C., 2160 g load) or greater do not adversely affect melt extrusion. Viscosities corresponding to melt indices of 50 g/10 min (210° C., 2160 g load) or less do not reduce film formability.

Preferable examples of EVOHs include SG464B and SG372B (both manufactured by Nippon Synthetic Chemical Industry Co., Ltd.).

Moreover, smectite, fluorine mica-based minerals and like inorganic water-absorptive substances may be contained insofar as the effects of the present invention are not adversely affected.

The EVOH layer of the present invention contains a polyamide-based resin, alcohol-based compound and EVOA as essential ingredients, and is prepared by melt-blending a polyamide-based resin with an alcohol-based compound, and then mixing the melt mixture with an EVOH.

The proportion of polyamide-based resin to alcohol-based compound in the melt blend is not limited. Usually, the weight ratio of polyamide-based resin/alcohol-based compound is preferably 99/1 to 60/40, and more preferably 98/2 to 55/45. Melt blending may be performed at 100 to 280° C., and preferably 125 to 275° C. The mode of melt blending is not limited, and melt blending can be performed using extruders such as uniaxial extruders, biaxial extruders, etc.

When an EVOH is added to a melt mixture of a polyamide-based resin and an alcohol-based compound, the weight ratio of the melt mixture to EVOH is not limited. Usually, the weight ratio of the melt mixture/EVOH is 4/96 to 40/60. It is preferable to mix the melt mixture with EVOH by melt blending. The melting temperature for this melt blending may be 150 to 250° C., and is preferably 155 to 245° C. The mode of melt blending is not limited, and melt blending can be performed, as described above, using extruders such as uniaxial extruders, biaxial extruders, etc.

In addition, it is possible to add, insofar as the effects of the present invention are not adversely affected, antioxidants, lubricants, ultraviolet absorbers, flame retardants, colorants, antiblocking agents, antistatic agents, fillers, and the like to the resin for forming the EVOH layer of the present invention. Moreover, the EVOH layer may contain salts of metals (alkali metals, alkaline earth metals, transition metals, etc.), boron, silica, etc.

II. Polyamide Layer

The polyamide layer of the present invention contains a polyamide and an antioxidant as essential ingredients.

The polyamide used for the polyamide layer of the present invention contains an aliphatic polyamide as an essential ingredient and may contain an aromatic polyamide, amorphous polyamide, polyamide elastomer or the like as necessary.

Examples of aliphatic polyamides include aliphatic nylons and copolymers thereof. Specific examples are polycapramide (nylon-6), poly-ω-aminoheptanoic acid (nylon-7), poly-ω-aminononanoic acid (nylon-9), polyundecaneamide (nylon-11), polylauryllactam (nylon-12), polyethylenediamine adipamide (nylon-2,6), polytetramethylene adipamide (nylon-4,6), polyhexamethylene adipamide (nylon-6,6), polyhexamethylene sebacamide (nylon-6,10), polyhexamethylene dodecamide (nylon-6,12), polyoctamethylene adipamide (nylon-8,6), polydecamethylene adipamide (nylon-10,8), caprolactam/lauryllactam copolymers (nylon 6/12), caprolactam/ω-aminononanoic acid copolymers (nylon 6/9), caprolactam/hexamethylenediammonium adipate copolymers (nylon-6/6,6), lauryllactam/hexamethylene diammonium adipate copolymers (nylon-12/6,6), ethylenediamine adipamide/hexamethylene diammonium adipate copolymers (nylon-2,6/6,6), caprolactam/hexamethylene diammonium adipate/hexamethylene diammonium sebacate copolymers (nylon-6,6/6,10), ethylene ammonium adipate/hexamethylene diammonium adipate/hexamethylene diammonium sebacate copolymers (nylon-6/6,6/6,10), 6T-6I nylon, and MXD-6 nylon. Two or more such polyamides can be used in combination. The amount of aliphatic polyamide in the polyamide layer is about 30 to about 99 wt. %, preferably about 50 to about 99 wt. %, and more preferably about 80 to about 96 wt. %.

Examples of aromatic polyamides are xylylene diamine-based polyamides, and in particular, polymers produced from m- and/or p-xylylene diamine with dicarboxylic acids such as adipic acid and the like.

An example of an amorphous polyamide is an isophthalic acid-terephthalic acid-hexamethylenediamine polycondensate.

An example of a polyamide elastomer is a polyether ester amide.

The total amount of aromatic polyamide, amorphous polyamide and/or polyamide elastomer in the polyamide layer is about 0 to about 40 wt. %, and preferably about 2.0 to about 30 wt. %.

Furthermore, in order to enhance the pinhole resistance of the resulting film, ingredients that can give flexibility to the film may be used, for example, modified ethylene-vinyl acetate copolymers, and ethylene-methacrylic acid copolymer ionomers. Modified ethylene-vinyl acetate copolymers herein include (1) those in which —OCOCH₃ groups are partially saponified, (2) those in which —OCOCH₃ is partially replaced with —OCOCH₂CH₃, and (3) those to which an acid anhydride such as maleic anhydride is partially graft-polymerized.

The amount of flexibility-giving ingredient in the polyamide layer is about 0 to about 30 wt. %, preferably about 0.5 to about 10 wt. %, and particularly preferably about 1.5 to about 6.0 wt. %.

Preferable examples of antioxidants usable in the polyamide layer of the present invention are phenol-based antioxidants, phosphorus-based antioxidants, and the like. Examples of phenol-based antioxidants are 3,9-bis[2-{3-(3-t-butyl-4-hydroxy-5-methylphenyl)propionyloxy}-1,1-dimethylethyl]-2,4,8,10-tetraoxaspiro[5,5]undecane, 6-[3-(3-t-butyl-4-hydroxy-5-methylphenyl)propoxy]-2,4,8,10-tetra-t-butylbenz[d,f][1,3,2]dioxaphosphepin, pentaerythrityl-tetrakis[3-(3,5-di-t-butyl-4-hydroxyphenyl)propionate], etc. Examples of phosphorus-based antioxidants are tris(2,4-di-t-butylphenyl)phosphite and the like. At least one phenol-based antioxidant selected from the following group is preferable: 3,9-bis[2-{3-(3-t-butyl-4-hydroxy-5-methylphenyl)propionyloxy}-1,1-dimethylethyl]-2,4,8,10-tetraoxaspiro[5,5]undecane, 6-[3-(3-t-butyl-4-hydroxy-5-methylphenyl)propoxy]-2,4,8,10-tetra-t-butylbenz[d,f][1,3,2]dioxaphosphepin, and pentaerythrityl-tetrakis[3-(3,5-di-t-butyl-4-hydroxyphenyl)propionate]. It is presumed that use of such specific antioxidants effectively inhibits the whitening of aliphatic polyamides, which are usually easily whitened by heating.

The amount of antioxidant in the polyamide layer is usually about 100 to about 5000 ppm, and preferably about 200 to about 2000 ppm. For specific example, 3,9-bis[2-{3-(3-t-butyl-4-hydroxy-5-methylphenyl)propionyloxy}-1,1-dimethylethyl]-2,4,8,10-tetraoxaspiro[5,5]undecane may be used in an amount of about 300 to about 600 ppm, and 6-[3-(3-t-butyl-4-hydroxy-5-methylphenyl)propoxy]-2,4,8,10-tetra-t-butylbenz[d,f][1,3,2]dioxaphosphepin may be used in an amount of about 50 to about 110 ppm.

The polyamide layer of the present invention may contain, insofar as the effects of the invention are not impaired, other types of polymers and organic additives such as heat stabilizers, lubricants, ultraviolet absorbers, etc., in standard amounts.

III. Aromatic Polyamide Layer

In addition to the EVOH layer and polyamide layer described above, the polyamide-based multilayer film of the present invention may contain one or more aromatic polyamide layers. Examples of aromatic polyamides are aromatic nylons, poly(m-xylylene adipamide), etc. Examples of aromatic nylons are S6007 (manufactured by Mitsubishi Gas Chemical Company, Inc.) and the like.

IV. Polyamide-Based Multilayer Film

The polyamide-based multilayer film of the present invention contains at least one EVOK layer and at least one polyamide layer, with the at least one EVOH layer functioning as a barrier layer.

Within the polyamide-based multilayer film of the present invention, when an EVOH layer is (A) and polyamide layers are (B) and (C), two layers disposed in the order of (B)/(A) or three layers disposed in the order of (B)/(A)/(C) may be present. The compositions and thicknesses of layers (B) and (C) may be the same or different. Since the polyamide-based multilayer film has at least three layers, one or more aromatic polyamide layers (D) as described above may be present as outer most layer(s) or between layers.

Among the polyamide-based multilayer films encompassed within the scope of the present invention, 3-layer films in which layers are laminated in the order of (B)/(A)/(C), 4-layer films in which layers are laminated in the order of (B)/(A)/(C)/(C) or (B)/(A)/(B)/(C), 5-layer films in which layers are laminated in the order of (B)/(A)/(C)/(A)/(B), 7-layer films in which layers are laminated in the order of (C)/(B)/(A)/(C)/(A)/(B)/(C), and the like are preferable. Among such films, 3-layer films in which layers are laminated in the order of (B)/(A)/(C) are particularly preferable.

A preferable example of the composition of polyamide layers (B) and (C) is such that in each polyamide layer a polyamide (containing nylon-6 as a principal ingredient) is contained in an amount of 30 wt. % or greater (and preferably about 40 to about 99 wt. %); a phenol-based antioxidant (3,9-bis[2-{3-(3-t-butyl-4-hydroxy-5-methylphenyl)propionyloxy}-1,1-dimethylethyl]-2,4,8,10-tetraoxaspiro[5,5]undecane, 6-[3-(3-t-butyl-4-hydroxy-5-methylphenyl)propoxy]-2,4,8,10-tetra-t-butylbenz[d,f][1,3,2]dioxaphosphepin, pentaerythrityl-tetrakis[3-(3,5-di-t-butyl-4-hydroxyphenyl)propionate], or the like) is contained in an amount of about 100 to about 5000 ppm (and preferably about 200 to about 2000 ppm); and a modified ethylene-vinyl acetate copolymer, ethylene-methacrylic acid copolymer ionomer, or the like is contained in an amount of about 0 to about 30 wt. %.

A preferable example of EVOH layer (A) contains a polyamide-based resin (containing nylon-6 as a principal ingredient) in an amount of about 0.5 to about 20 wt. %, an alcohol-based compound (such as 2,3-butanediol) in an amount of about 0.2 to about 10 wt. %, and an EVOH (in which ethylene is contained in an amount of about 20 to about 60 mol %, and the degree of saponification of the vinyl acetate moieties is at least 95 mol %) in an amount of about 70 to about 99.3 wt. %.

V. Method for Producing the Polyamide-Based Multilayer Film

The polyamide-based multilayer film of the present invention may be prepared in the form of a multilayer flat film by, for example, coextruding the resins for each of the layers in a suitable order through a T-die onto a chill roll in which cooling water circulates. The resulting film is longitudinally stretched 2 to 4 times its original length by a roll stretching machine at 50 to 100° C., transversely stretched 2 to 5 times its original width by a tenter stretching machine at an ambient temperature of 90 to 150° C., and annealed by the same tenter stretching machine at an ambient temperature of 100 to 240° C. The multilayer film of the present invention may be uniaxially stretched or biaxially stretched (simultaneously or sequentially biaxially stretched). One or both sides of the resulting multilayer film may be subjected to corona discharge treatment if necessary.

The thickness of the entire polyamide-based multilayer film of the present invention is about 10 to about 50 μm, and preferably about 12 to about 40 μm. For example, the thickness of a polyamide layer is about 3 to about 20 μm, and preferably about 5 to about 10 μm. The thickness of an EVOH layer is about 2 to about 10 μm, and preferably about 3 to about 10 μm, with about 5 to about 10 μm being particularly preferable to restrict oxygen permeability. When there is an aromatic polyamide layer, the thickness thereof is about 2 to about 15 μm, and preferably about 3 to about 10 μm.

VI. Feature of the Polyamide-Based Multilayer Film

The polyamide-based multilayer film of the present invention as prepared above has excellent boiling/retorting suitability (resistance to boiling water and resistance to retort treatment). That is, in addition to excellent mechanical strength, pinhole resistance and gas barrier properties, the polyamide-based multilayer film has the feature of not whitening when heated. This is presumably because the polyamide-based multilayer film uses a specific EVOH as a barrier layer and has polyamide layers containing a specific antioxidant.

The aesthetic appearance of prior-art films is likely to be impaired due to film whitening once these films are subjected to boiling-water/retort treatment. The polyamide-based multilayer film of the present invention, however, does not whiten as a result of boiling-water/retort treatment and maintains excellent transparency. As a specific example, the polyamide-based multilayer film of the present invention does not whiten at all even after a boiling water treatment (30 minutes in 85° C. to boiling water) or a retort treatment (30 minutes at 121 to 135° C.), and the appearance thereof remains transparent.

The polyamide-based multilayer film of the present invention is hence advantageously used in food packaging for boiling-water/retort sterilization in particular.

### BEST MODE FOR CARRYING OUT THE INVENTION

Examples are given below to illustrate the invention in more detail; however, the scope of the invention is not limited to these examples.

### Example 1

A resin composition for the polyamide layer of the present invention was prepared by mixing nylon-6 (87 parts by weight); a modified ethylene-vinyl acetate copolymer (2.5 parts by weight); an ethylene-methacrylic acid copolymer ionomer (0.5 parts by weight); as antioxidants, 3,9-bis[2-{3-(3-t-butyl-4-hydroxy-5-methylphenyl)propionyloxy}-1,1-dimethylethyl]-2,4,8,10-tetraoxaspiro[5,5]undecane (0.0060 parts by weight) and 6-[3-(3-t-butyl-4-hydroxy-5-methylphenyl)propoxy]-2,4,8,10-tetra-t-butylbenz[d,f][1,3,2]dioxaphosphepin (0.010 parts by weight); and an aromatic nylon (10 parts by weight). A resin composition having the same makeup as described above can be used for the polyamide layer.

A composite EVOH resin containing a polyamide-based resin, an alcohol-based resin and an EVOH (SG464B, manufacture by Nippon Synthetic Chemical Industry Co., Ltd.) was used as a resin composition for the EVOH layer.

A 3-layer flat film was prepared by coextruding the resin compositions for each of the layers so as to stack up the layers in the order of polyamide layer/EVOH layer/polyamide layer through a T-die onto a chill roll in which cooling water was circulating. The resulting film was longitudinally stretched 3.0 times its original length by a roll stretching machine at 65° C., transversely stretched 3.5 times its original width by a tenter stretching machine at an ambient temperature of 100 to 120° C., and annealed by the same tenter stretching machine at an ambient temperature of 210° C.

The thickness of each layer of the resulting 3-layer polyamide-based film was 6.5 μm/4.9 μm/6.5 μm in the order of polyamide layer/EVOH layer/polyamide layer, respectively.

### Example 2

Another 3-layer polyamide-based film was obtained in a similar manner as in Example 1. The thickness of each layer was 6.0 μm/8.0 μm/6.0 μm in the order of polyamide layer/EVOH layer/polyamide layer, respectively.

### Comparative Example 1

Polyamide layers were prepared in the same manner as in Example 1. For an EVOH layer, an ethylene/vinyl alcohol copolymer that does not contain polyamide (ethylene content: 32 mol %, DC3203FB, manufactured by Nippon Synthetic Chemical Industry Co., Ltd.) was used.

A 3-layer polyamide-based film was obtained in a similar manner as in Example 1. The thickness of each layer was 6.0 μm/3.0 μm/6.0 μm in the order of polyamide layer/EVOH layer/polyamide layer, respectively.

### Comparative Example 2

Polyamide layers were prepared in the same manner as in Example 1. For an EVOH layer, an ethylene/vinyl alcohol copolymer that does not contain polyamide (ethylene content: 32 mol %, DT2903B, manufactured by Nippon Synthetic Chemical Industry Co., Ltd.) was used.

A 3-layer polyamide-based film was obtained in a similar manner as in Example 1. The thickness of each layer was 6.0 μm/5.0 μm/6.0 μm in the order of polyamide layer/EVOH layer/polyamide layer, respectively.

### Comparative Example 3

A 3-layer polyamide-based film was obtained in a similar manner as in Example 1 except that the makeup of each polyamide layer was: nylon-6 (87 parts by weight) and aromatic nylon (10 parts by weight). The thickness of each layer was 6.0 μm/5.0 μm/6.0 μm in the order of polyamide layer/EVOH layer/polyamide layer, respectively.

### Comparative Example 4

A 3-layer polyamide-based film was obtained in a similar manner as in Example 1 except that the makeup of each polyamide layer was: nylon-6 (87 parts by weight), aromatic nylon (10 parts by weight) and modified ethylene-vinyl acetate copolymer ionomer (2.5 parts by weight), with no antioxidant being used. The thickness of each layer was 6.0 μm/5.0 μm/6.0 μm in the order of polyamide layer/EVOH layer/polyamide layer, respectively.

### Test Example 1

### Evaluation of Film Whitening

Polyamide-based multilayer films of Examples 1 and 2 and Comparative Examples 1 to 4 after boiling water treatment (85° C.×30 min, 90° C.×30 min, or boiling water×30 min) or retort treatment (121° C.×30 min or 135° C.×30 min) were observed with the naked eye to evaluate film whitening. Evaluation criteria: ◯: no whitening, Δ: slight whitening, X: strong whitening

TABLE 1

| | Boiling water treatment | | | | |
|---|---|---|---|---|---|
| | | | Boiling | Retort treatment* | |
| | 85° C. × | 90° C. × | water × | 121° C. × | |
| | 30 min | 30 min | 30 min | 30 min | 135° C. × 30 min |
| Ex. 1 | ◯ | ◯ | ◯ | ◯ | ◯ |
| Ex. 2 | ◯ | ◯ | ◯ | ◯ | ◯ |
| Comp. | ◯ | Δ | X | X | X |
| Ex. 1 | | | | | |
| Comp. | ◯ | Δ | X | X | X |
| Ex. 2 | | | | | |
| Comp. | ◯ | ◯ | ◯ | ◯ | Δ |
| Ex. 3 | | | | | |
| Comp. | ◯ | ◯ | ◯ | Δ | Δ |
| Ex. 4 | | | | | |

*Retort treatment performed using Autoclave AC-30L manufactured by Alup. Corp.

As shown in Table 1, the polyamide-based multilayer films of the present invention (Examples 1 and 2) did not turn white at all during either boiling water treatment or retort treatment, and remained transparent. In contrast, with regard to the films of Comparative Examples 1 to 4, whitening was observed in some films in treatments at a temperature as low as 90° C., and all the films whitened during a 135° C. retort treatment.

### Test Example 2

### Comparison of Other Physical Properties

Physical properties of the polyamide-based multilayer films of Examples 1 and 2 and Comparative Examples 1 to 4 are presented in Tables 2 to 4. Physical properties of the films of Examples 1 and 2 and Comparative Examples 3 and 4 after a retort treatment (121° C.×30 min) are presented in Tables 5 and 6. The measurement methods selected for the measured items are as shown in the column “measurement method”.

TABLE 2

| | |
|---|---|
| Ex. 1 | Ex. 2 |

| | | | | | | |
|---|---|---|---|---|---|---|
| Item | Units | MD | TD | MD | TD | Measurement method |

| Average thickness | | μm | 16.6 | | 20.7 | | |
|---|---|---|---|---|---|---|---|
| Haze | | % | 6.8 | | 6.4 | | ASTM D-1003 |
| Tensile strength | | MPa | 196 | 255 | 161 | 243 | JIS K-7127 |
| Tensile elongation | | % | 140 | 85 | 120 | 68 | |
| Coefficient | inside/inside | — | 0.59/0.51 | | 0.54/0.51 | | ASTM D-1894 |
| of friction | outside/outside | | 0.38/0.36 | | 0.59/0.51 | | |
| Heat | Boiling | % | 2.0 | 0 | 2.0 | 0.8 | Hot water × 30 sec |
| shrinkage | water | | | | | | |

| | | | | | | |
|---|---|---|---|---|---|---|
| Dry heat | % | 1.1 | 0 | 1.0 | 0.3 | 120° C. × 15 min |

| Wetting | Inner surface | mN/m | at least 54 | at least 54 | JIS K-6768 |
|---|---|---|---|---|---|
| exponent | Outer surface | | 43 | at least 54 | |
| Puncturability | | N | 9.6 | 11.0 | The Japanese Ministry |
| | | | | | of Health and Welfare |
| | | | | | Notification No. 17 of |
| | | | | | 1979 |
| Impact strength | | J | 0.9 | 0.9 | Punching impact tester |
| Gelbo | 1000 times at | — | 1, 2, 3 | 8, 8, 14 | The number of holes |
| flex | room temperature | | | | counted over an area |
| tester | 1000 times at 5° C. | | 5, 5, 6 | 16, 20, 20 | of 300 cm² |

| | | | | |
|---|---|---|---|---|
| Interlayer adhesion | N/cm | 3.3 | 3.1 | |
| Oxygen permeability | *1 | 2.5 | 1.2 | ASTM D-3985 |
| | *2 | 24.5 | 11.8 | |

*1: cc/m² · 24 h · atm · 20° C. × 65% RH
*2: ml/m² · d · MPa · 20° C. × 65% RH

TABLE 3

| | | | Comp. | | Comp. | | |
|---|---|---|---|---|---|---|---|
| | | | Ex. 1 | | Ex. 2 | | |
| Item | | Units | MD | TD | MD | TD | Measurement method |
| Average thickness | | μm | 14.9 | | 16.6 | | |
| Haze | | % | 7.0 | | 6.8 | | ASTM D-1003 |
| Tensile strength | | MPa | 197 | 250 | 196 | 255 | JIS K-7127 |
| Tensile elongation | | % | 138 | 70 | 140 | 85 | |
| Coefficient | inside/inside | — | 0.62/0.59 | | 0.59/0.51 | | ASTM D-1894 |
| of friction | outside/outside | | 0.36/0.33 | | 0.38/0.33 | | |
| Heat | Boiling | % | 2.3 | −0.3 | 2.0 | 0.3 | Hot water × 30 sec |
| shrinkage | water | | | | | | |

| | | | | | | |
|---|---|---|---|---|---|---|
| Dry heat | % | 1.0 | −0.4 | 1.3 | −0.5 | 120° C. × 15 min |

| Wetting | Inner surface | mN/m | at least 54 | at least 54 | JIS K-6768 |
|---|---|---|---|---|---|
| exponent | Outer surface | | 43 | 43 | |
| Puncturability | | N | 8.3 | 9.3 | The Japanese Ministry |
| | | | | | of Health and Welfare |
| | | | | | Notification No. 17 of |
| | | | | | 1979 |
| Impact strength | | J | 0.9 | 1.1 | Punching impact tester |
| Gelbo | 1000 times at | — | 0, 1, 1 | 1, 2, 2 | The number of holes |
| flex | room temperature | | | | counted over an area |
| tester | 1000 times at 5° C. | | 4, 4, 8 | 2, 3, 5 | of 300 cm² |

| | | | | |
|---|---|---|---|---|
| Interlayer adhesion | N/cm | 3.3 | 2.9 | |
| Oxygen permeability | *1 | 1.8 | 0.60 | ASTM D-3985 |
| | *2 | 17.8 | 5.9 | |

*1: cc/m² · 24 h · atm · 20° C. × 65% RH
*2: ml/m² · d · MPa · 20° C. × 65% RH

TABLE 4

| | | | Comp. | | Comp. | | |
|---|---|---|---|---|---|---|---|
| | | | Ex. 3 | | Ex. 4 | | |
| Item | | Units | MD | TD | MD | TD | Measurement method |
| Average thickness | | μm | 17.0 | | 16.8 | | |
| Haze | | % | 5.0 | | 6.5 | | ASTM D-1003 |
| Tensile strength | | MPa | 208 | 267 | 198 | 260 | JIS K-7127 |
| Tensile elongation | | % | 136 | 80 | 143 | 85 | |
| Coefficient | inside/inside | — | 0.59/0.53 | | 0.59/0.51 | | ASTM D-1894 |
| of friction | outside/outside | | 0.38/0.36 | | 0.36/0.33 | | |
| Heat | Boiling | % | 1.8 | 0 | 2.0 | 0 | Hot water × 30 sec |
| shrinkage | water | | | | | | |

| | | | | | | |
|---|---|---|---|---|---|---|
| Dry heat | % | 1.1 | 0 | 1.0 | 0 | 120° C. × 15 min |

| Wetting | Inner surface | mN/m | at least 54 | at least 54 | JIS K-6768 |
|---|---|---|---|---|---|
| exponent | Outer surface | | 43 | 43 | |
| Puncturability | | N | 9.8 | 9.6 | The Japanese Ministry |
| | | | | | of Health and Welfare |
| | | | | | Notification No. 17 of |
| | | | | | 1979 |
| Impact strength | | J | 0.9 | 0.9 | Punching impact tester |
| Gelbo | 1000 times at | — | 15, 20, 22 | 1, 2, 2 | The number of holes |
| flex | room temperature | | | | counted over an area of |
| tester | 1000 times at 50° C. | | 43, 50, 52 | 6, 6, 7 | 300 cm² |

| | | | | |
|---|---|---|---|---|
| Interlayer adhesion | N/cm | 2.1 | 3.2 | |
| Oxygen permeability | *1 | 2.5 | 2.5 | ASTM D-3985 |
| | *2 | 24.5 | 24.5 | |

*1: cc/m² · 24 h · atm · 20° C. × 65% RH
*2: ml/m² · d · MPa · 20° C. × 65% RH

TABLE 5
<After retort treatment (121° C. × 30 min)>

| | | Ex. 1 | | Ex. 2 | | Measurement |
|---|---|---|---|---|---|---|
| Item | Units | MD | TD | MD | TD | method |
| Haze | % | 6.8 | | 4.8 | | ASTM D-1003 |
| | | (100%) | | (133%) | | |
| Tensile strength | MPa | 176 | 233 | 153 | 208 | JIS K-7127 |
| | | (99%) | (94%) | (95%) | (86%) | |
| Tensile elongation | % | 130 | 75 | 123 | 65 | |
| | | (108%) | (103%) | (103%) | (96%) | |

| Puncturability | | N | 8.9 | 10.0 | The Japanese |
|---|---|---|---|---|---|
| | | | (93%) | (91%) | Ministry of Health |
| | | | | | and Welfare |
| | | | | | Notification No. |
| | | | | | 17 of 1979 |
| Impact strength | | J | 0.8 | 0.9 | Punching impact |
| | | | (89%) | (100%) | tester |
| Gelbo | 1000 times at | — | 2, 4, 4 | 9, 12, 12 | The number of |
| flex | room temperature | | (60%) | (91%) | holes counted over |
| tester | 1000 times at 5° C. | | 6, 8, 8 | 20, 22, 26 | an area of 300 cm² |
| | | (85%) | (82%) | | |

| | | | | |
|---|---|---|---|---|
| Oxygen permeability | *1 | 3.1 | 1.4 | ASTM D-3985 |
| | | (80%) | (86%) | |

*The percentages in “( )” indicate retention comparative to an untreated film

TABLE 6
<After retort treatment (121° C. × 30 min)>

| | | Comp. | | Comp. | | |
|---|---|---|---|---|---|---|
| | | Ex. 3 | | Ex. 4 | | Measurement |
| Item | Unit | MD | TD | MD | TD | method |
| Haze | % | 6.0 | | 8.1 | | ASTM D-1003 |
| | | (83%) | | (80%) | | |
| Tensile strength | MPa | 190 | 243 | 188 | 250 | JIS K-7127 |
| | | (91%) | (91%) | (95%) | (96%) | |
| Tensile elongation | % | 135 | 84 | 140 | 85 | |
| | | (99%) | (105%) | (98%) | (100%) | |

| Puncturability | | N | 9.3 | 9.3 | The Japanese |
|---|---|---|---|---|---|
| | | | (95%) | (97%) | Ministry of Health |
| | | | | | and Welfare |
| | | | | | Notification No. |
| | | | | | 17 of 1979 |
| Impact strength | | J | 0.8 | 0.8 | Punching impact |
| | | | (89%) | (89%) | tester |
| Gelbo | 1000 times at | — | 20, 23, 27 | 2, 4, 4 | The number of |
| flex | room | | (81%) | (50%) | holes counted over |
| tester | temperature | | | | an area of 300 cm² |
| | 1000 times at | | 51, 55, 60 | 7, 8, 10 | |
| | 5° C. | | (87%) | (76%) | |

| | | | | |
|---|---|---|---|---|
| Oxygen permeability | *1 | 3.0 | 3.1 | ASTM D-3985 |
| | | (83%) | (81%) | |
| | *2 | 29.6 | 30.6 | |
| | | (83%) | (81%) | |

*The percentages in “( )” indicate retention comparative to an untreated film

As can be understood from the tables, although there is not much difference in most physical properties between the films of Examples 1 and 2 and the films of Comparative Examples 1 to 4, the haze values of the films of Examples 1 and 2 after a retort treatment (121° C.×30 min) substantially remained the same while the haze values of the films of Comparative Examples 3 and 4 after a retort treatment (121° C.×30 min) were significantly deteriorated.

### EFFECT OF THE INVENTION

The polyamide-based multilayer film of the present invention has outstanding resistance to boiling water and retort treatment. In particular, a feature of the polyamide-based multilayer film is not whitening when heated. The polyamide-based multilayer film can therefore be suitably used for food packaging for boiling-water/retort sterilization.

1. A polyamide-based multilayer film comprising at least one saponified ethylene-vinyl acetate copolymer layer and at least one polyamide layer,
the at least one saponified ethylene-vinyl acetate copolymer layer comprising a polyamide-based resin, an alcohol-based compound, and a saponified ethylene-vinyl acetate copolymer,
the polyamide-based multilayer film being highly suitable for boiling and water treatment and retort treatment.

2. (canceled)

3. The polyamide-based multilayer film according to claim 1, wherein the saponified ethylene-vinyl acetate copolymer layer further comprises an inorganic water-absorptive substance.

4. The polyamide-based multilayer film according to claim 1, wherein the saponified ethylene-vinyl acetate copolymer layer is prepared by melt-blending a polyamide-based resin with an alcohol-based compound, and then adding a saponified ethylene-vinyl acetate copolymer.

5. The polyamide-based multilayer film according to claim 1, wherein the polyamide-based resin comprises an aliphatic nylon as a principal ingredient, the saponified ethylene-vinyl acetate copolymer has an ethylene content of 60 mol % or less, and the degree of saponification of the vinyl acetate moieties is at least 90 mol %.

6. The polyamide-based multilayer film according to claim 1, wherein the polyamide layer is a layer comprising a polyamide and an antioxidant.

7. The polyamide-based multilayer film according to claim 6, wherein the polyamide comprises an aliphatic polyamide as a principal ingredient and the antioxidant is a phenol-based antioxidant.

8. The polyamide-based multilayer film according to claim 7, wherein the phenol-based antioxidant is at least one member selected from the group consisting of 3,9-bis[2-{3-(3-t-butyl-4-hydroxy-5-methylphenyl)propionyloxy}-1,1-dimethylethyl]-2,4,8,10-tetraoxaspiro[5,5]undecane; 6-[3-(3-t-butyl-4-hydroxy-5-methylphenyl)propoxy]-2,4,8,10-tetra-t-butylbenz[d,f][1,3,2]dioxaphosphepin; and pentaerythrityl-tetrakis[3-(3,5-di-t-butyl-4-hydroxyphenyl)propionate].

9. The polyamide-based multilayer film according to claim 1 consisting of at least one saponified ethylene-vinyl acetate copolymer layer and at least one polyamide layer.

10. The polyamide-based multilayer film according to claim 1 comprising at least three layers in the order of polyamide layer/saponified ethylene-vinyl acetate copolymer layer/polyamide layer.

11. The polyamide-based multilayer film according to claim 10 further comprising an aromatic polyamide layer.

12. A method for producing a polyamide-based multilayer film, the method comprising the steps of:
coextruding a saponified ethylene-vinyl acetate copolymer layer (A) prepared by melt-blending a polyamide-based resin with an alcohol-based compound and then adding an ethylene-vinyl acetate copolymer thereto, together with polyamide layers (B) and (C) each comprising a polyamide and an antioxidant, in the order of (B)/(A)/(C) to form a laminated film; and
biaxially stretching the film.

13. The polyamide-based multilayer film according to claims 3, wherein the polyamide-based resin comprises an aliphatic nylon as a principal ingredient, the saponified ethylene-vinyl acetate copolymer has an ethylene content of 60 mol % or less, and the degree of saponification of the vinyl acetate moieties is at least 90 mol %.

14. The polyamide-based multilayer film according to claim 4, wherein the polyamide-based resin comprises an aliphatic nylon as a principal ingredient, the saponified ethylene-vinyl acetate copolymer has an ethylene content of 60 mol % or less, and the degree of saponification of the vinyl acetate moieties is at least 90 mol %.

15. The polyamide-based multilayer film according to claim 3 consisting of at least one saponified ethylene-vinyl acetate copolymer layer and at least one polyamide layer.

16. The polyamide-based multilayer film according to claim 4 consisting of at least one saponified ethylene-vinyl acetate copolymer layer and at least one polyamide layer.

17. The polyamide-based multilayer film according to claim 5 consisting of at least one saponified ethylene-vinyl acetate copolymer layer and at least one polyamide layer.

18. The polyamide-based multilayer film according to claim 6 consisting of at least one saponified ethylene-vinyl acetate copolymer layer and at least one polyamide layer.

19. The polyamide-based multilayer film according to claim 7 consisting of at least one saponified ethylene-vinyl acetate copolymer layer and at least one polyamide layer.

20. The polyamide-based multilayer film according to claim 8 consisting of at least one saponified ethylene-vinyl acetate copolymer layer and at least one polyamide layer.

21. The polyamide-based multilayer film according to claim 3 comprising at least three layers in the order of polyamide layer/saponified ethylene-vinyl acetate copolymer layer/polyamide layer.

22. The polyamide-based multilayer film according to claim 4 comprising at least three layers in the order of polyamide layer/saponified ethylene-vinyl acetate copolymer layer/polyamide layer.

23. The polyamide-based multilayer film according to claim 5 comprising at least three layers in the order of polyamide layer/saponified ethylene-vinyl acetate copolymer layer/polyamide layer.

24. The polyamide-based multilayer film according to claim 6 comprising at least three layers in the order of polyamide layer/saponified ethylene-vinyl acetate copolymer layer/polyamide layer.

25. The polyamide-based multilayer film according to claim 7 comprising at least three layers in the order of polyamide layer/saponified ethylene-vinyl acetate copolymer layer/polyamide layer.

26. The polyamide-based multilayer film according to claim 8 comprising at least three layers in the order of polyamide layer/saponified ethylene-vinyl acetate copolymer layer/polyamide layer.

27. A polyamide-containing multilayer transparent film comprising:
at least one saponified ethylene-vinyl acetate copolymer layer comprising: (i) a polyamide-based resin which contains nylon-6 as a principal ingredient; (ii) an alcohol-based compound which contains alcoholic OH group, and (iii) a saponified ethylene-vinyl acetate copolymer; and
at least one polyamide layer laminated on the saponified ethylene-vinyl acetate copolymer layer,
said polyamide-based multilayer film having boiling resistance as measured by transparency substantially unchanged for 30 minutes or longer in boiling water at 85° C. or for 30 minutes or longer in retort treatment at 121-135° C.

28. The polyamide-containing multilayer transparent film according to claim 27, wherein a weight ratio of the polyamide-based resin to the alcohol-based compound is 99/1 to 60/40.

29. The polyamide-containing multilayer transparent film according to claim 27, wherein the saponified ethylene-vinyl acetate copolymer layer and the polyamide layer are laminated by co-extrusion and biaxial stretching.

30. The polyamide-containing multilayer transparent film according to claim 27, wherein the at least one saponified ethylene-vinyl acetate copolymer layer is a center layer, and the at least one polyamide layer comprises two layers between which the center layer is sandwiched.
